(19) United States
(12) Patent Application Publication
(10) Pub. No.: US 2006/0251286 A1
(43) Pub. Date: Nov. 9, 2006

(54) Multi-gap air return motor for electromagnetic transducer

(76) Inventor: Enrique M. Stiles, Imperial Beach, CA (US)

Correspondence Address: RICHARD C. CALDERWOOD, 2775 NW 126TH AVE, PORTLAND, OR, 97229-8381, US

(21) Appl. No.: 11/194,258

(22) Filed: Aug. 1, 2005

Related U.S. Application Data
(63) Continuation-in-part of application No. 11/105,779, filed on Apr. 13, 2005.
(63) Continuation-in-part of application No. 11/114,737, filed on Apr. 25, 2005.

(51) Int. Cl. H04R 9/06

(52) U.S. Cl. 381/421

(57) ABSTRACT

An electromagnetic transducer such as an audio speaker, having a multi-gap air-return motor. The use of an air return geometry lacking motor components in the region outside the voice coil assembly permits the spider and cone to be coupled to the bobbin much lower, significantly reducing the thickness of the transducer. The use of multiple high-flux regions increases Xmax.

### RELATED APPLICATION

This application is a continuation-in-part of U.S. patent application Ser. No. 11/105,779 entitled “Dual-Gap Transducer with Radially-Charged Magnet” filed Apr. 13, 2005 by this inventor, and a continuation-in-part of U.S. patent application Ser. No. 11/114,737 entitled “Semi-Radially-Charged Conical Magnet for Electromagnetic Transducer” filed Apr. 25, 2005 by this inventor, all commonly assigned.

### BACKGROUND OF THE INVENTION

1. Technical Field of the Invention

This invention relates generally to electromagnetic transducers such as audio loudspeakers, and more specifically to a transducer motor structure utilizing multiple high flux regions for increased Xmax, and allowing for a transducer with a reduced axial height.

2. Background Art

The terms “internal” and “external” generally refer to whether an electromagnetic transducer component, such as a magnet, yoke, plate, spider, diaphragm, etc. is located radially inside the transducer's voice coil assembly, or radially outside the voice coil assembly, respectively. The terms “lower” and “upper” generally refer to components with respect to their axial position within the transducer, with upper components being nearer the “front” or sound-producing end of the transducer, and lower components being nearer the “back” or motor end of the transducer; no specific transducer orientation is implied by either term.

Conventional electromagnetic transducers utilize motor structures which have yokes, magnets, or other fixed external components. Because these external components would otherwise interfere with various moving external components, the transducer is made significantly deeper in the axial direction, with a greatly elongated bobbin, to provide clearance between the moving external components and the fixed external components.

FIG. 1 illustrates a conventional electromagnetic transducer 10 having an external magnet geometry motor structure. The transducer includes a motor 12 coupled to a diaphragm assembly 14 by a frame 16. The diaphragm assembly includes a diaphragm 18 which is coupled to the frame by an upper suspension component 20 such as a surround. The diaphragm is typically equipped with a dust cap 21. A voice coil assembly includes a voice coil 22 wound onto the lower end of a bobbin 24, with the upper end of the bobbin being coupled to the diaphragm. The upper end of the bobbin is also coupled to the frame by a lower suspension component 26 such as a spider.

The motor includes a pole plate 28 which includes a pole piece 30 which extends internally within the voice coil assembly, and a back plate 32 which extends outwardly beyond the voice coil assembly. One or more external magnets 34 are magnetically coupled to the back plate, and an external top plate 36 is magnetically coupled to the magnets.

The internal pole plate and the external top plate define a magnetic air gap 38 in which the magnetic flux is highly concentrated. The advantage of this conventional motor is that, other than the magnetic air gap, the motor provides a very-low-reluctance magnetic circuit path, in which the magnetic flux is conducted very efficiently.

Because the voice coil assembly moves axially, there must be sufficient clearance between the lower suspension component and the uppermost fixed external motor component such as the top plate, or, in the example shown, the backing plate of the frame which is coupled to the top plate. Otherwise, when the motor pulls the voice coil into the motor, the lower suspension component will strike the topmost external fixed component. This requires that the bobbin be elongated, with a significant space between the voice coil and the spider. The end result is that the transducer as a whole is made deeper (or “thicker”). Also, the increased distance between the lower end of the voice coil assembly and the spider reduces the suspension components'ability to prevent rocking, and the voice coil assembly may rock and strike the motor.

FIG. 2 illustrates a conventional electromagnetic transducer 40 having an internal magnet geometry motor structure including a motor 42 coupled to a diaphragm assembly 44 by a frame 46. The motor includes an external yoke 48 such as a cup. An internal magnet 50 is magnetically coupled within the cup, and an internal top plate 52 is magnetically coupled to the magnet. The top plate and the yoke define a magnetic air gap 54. The diaphragm assembly includes a voice coil 56 wound onto the lower end of a bobbin 58. A lower suspension component 60 such as a spider is coupled to the frame, and is coupled to the bobbin sufficiently near the upper end that it does not strike the uppermost external component during inward movement of the voice coil assembly.

U.S. Pat. No. 6,865,282 “Loudspeaker Suspension for Achieving Very Long Excursion” to Rick Weisman illustrates an excellent transducer which uses an ingenious spring spider and slotted cup to reduce the transducer thickness for a given Xmax travel, while preventing the lower suspension component from striking the uppermost fixed external structure. Axial slots in the cup provide axial clearance, and the spring spider provides lower suspension in only those locations.

U.S. Pat. No. 5,550,332 “Loudspeaker Assembly” and U.S. Pat. No. 5,701,657 “Method of Manufacturing a Repulsion Magnetic Circuit Type Loudspeaker” to Yoshio Sakamoto, and U.S. Pat. No. 5,590,210 “Loudspeaker Structure and Method of Assembling Loudspeaker” and U.S. Pat. No. 5,701,357 “Loudspeaker Structure with a Diffuser” to Shinta Matsuo and Yoshio Sakamoto illustrate transducers which avoid external fixed components altogether. In each, the motor consists of an internal top plate sandwiched between oppositely-charged magnets. These motors do not have a magnetic air gap, and do not have a low-reluctance magnetic circuit. Instead, they rely on high-reluctance leakage air paths for their magnetic flux return. The purpose of the oppositely-charged second magnet is to increase the magnetic flux at the outer perimeter of the top plate. Without a low reluctance return path in the circuit, a single magnet does not provide much flux to the voice coil, and the second magnet somewhat improves this.

Unfortunately, all of these prior art transducers provides only a single region of high flux density, whether it be a magnetic air gap between a top plate and a yoke, or a region adjacent a top plate in a yokeless air return circuit.

U.S. Pat. No. 6,917,690 “Electromagnetic Transducer Having Multiple Magnetic Air Gaps Whose Magnetic Flux is in a Same Direction” to this inventor teaches a transducer having dramatically increased Xmax provided by a pair of magnetic air gaps which perform a “hand-off” of a voice coil from one gap to the other.

What is needed, then, is an improved motor structure which does not require external motor components in positions where they would be struck by the lower suspension, and which provides large Xmax in a relatively thin transducer.

### BRIEF DESCRIPTION OF THE DRAWINGS

FIG. 1 shows an electromagnetic transducer having an external magnet geometry motor according to the prior art.

FIG. 2 shows an electromagnetic transducer having an internal magnet geometry motor according to the prior art.

FIG. 3 shows a motor structure according to one embodiment of this invention.

FIG. 4 shows an electromagnetic transducer using the motor structure of FIG. 3.

FIG. 5 shows the electromagnetic transducer of FIG. 4 in an exploded view.

FIG. 6 shows an electromagnetic transducer using the motor structure of FIG. 3 and a partially flattened diaphragm assembly.

FIG. 7 shows an electromagnetic transducer using a similar motor structure, stamped steel basket, and a flat diaphragm assembly.

FIG. 8 shows an electromagnetic transducer using a stamped steel basket and a flux gathering member at the opposite end of the motor, beneath the diaphragm assembly.

FIG. 9 shows an electromagnetic transducer using a stamped steel basket, a flux gathering member beneath the diaphragm assembly, and flux-carrying steel bolts which penetrate the cone and lower suspension component.

FIG. 10 shows a motor structure having a radially-charged magnet according to yet another embodiment of this invention.

FIG. 11 shows yet another motor structure according to this invention, using a radially-charged magnet and a pair of ring magnets.

FIG. 12 shows an electromagnetic transducer using the motor structure of FIG. 11.

FIG. 13 shows an electromagnetic transducer using a motor structure having a conical semi-radially-charged magnet, and a ring magnet.

FIG. 14 shows a different motor using radially-charged conical magnets.

FIG. 15 shows yet another motor using semi-radially-charged conical magnets.

FIG. 16 shows another motor using a radially-charged magnet having a double-conical shape, and also using a shorting ring.

FIG. 17 shows a motor using a semi-radially-charged conical magnet, a pair of ring magnets, a shorting ring, dual voice coils, and flux-gathering steel rings mounted to the voice coils.

FIG. 18 shows another motor using a conical magnet and a ring magnet.

FIG. 19 shows a transducer using the motor of FIG. 18.

FIGS. 20 and 21 show two embodiments of motors having more than two high flux regions.

FIG. 22 is a computer model generated flux line diagram for a motor, and FIG. 23 is its corresponding magnetic flux density chart.

FIG. 24 is a computer model generated flux line diagram for another motor, and FIG. 25 is its corresponding magnetic flux density chart.

FIG. 26 is a computer model generated flux line diagram for a yet another motor, and FIG. 27 is its corresponding magnetic flux density chart.

FIG. 28 is a computer model generated flux line diagram for still another motor, and FIG. 29 is its corresponding magnetic flux density chart.

FIG. 30 is a motor according to yet another embodiment of this invention, using a reverse-polarity radially-charged magnet between the top plates.

FIG. 31 is a transducer using the motor of FIG. 30.

FIG. 32 is a computer model generated flux line diagram for a motor similar to that of FIG. 30 but lacking end plates, and FIG. 33 is its corresponding magnetic flux density chart.

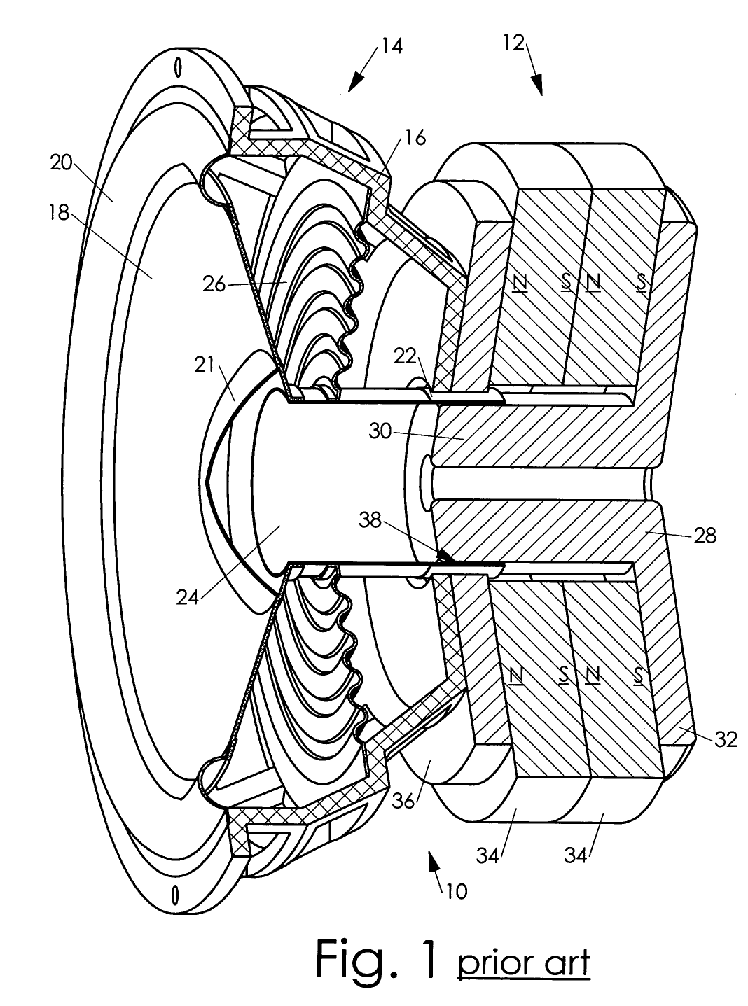

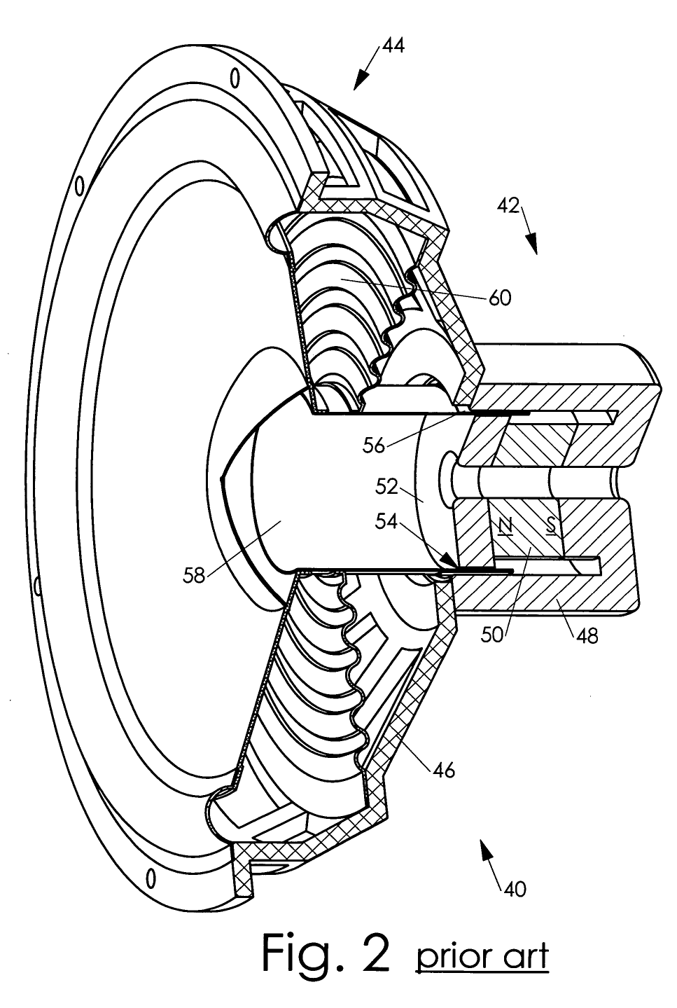

### DETAILED DESCRIPTION

The invention will be understood more fully from the detailed description given below and from the accompanying drawings of embodiments of the invention which, however, should not be taken to limit the invention to the specific embodiments described, but are for explanation and understanding only.

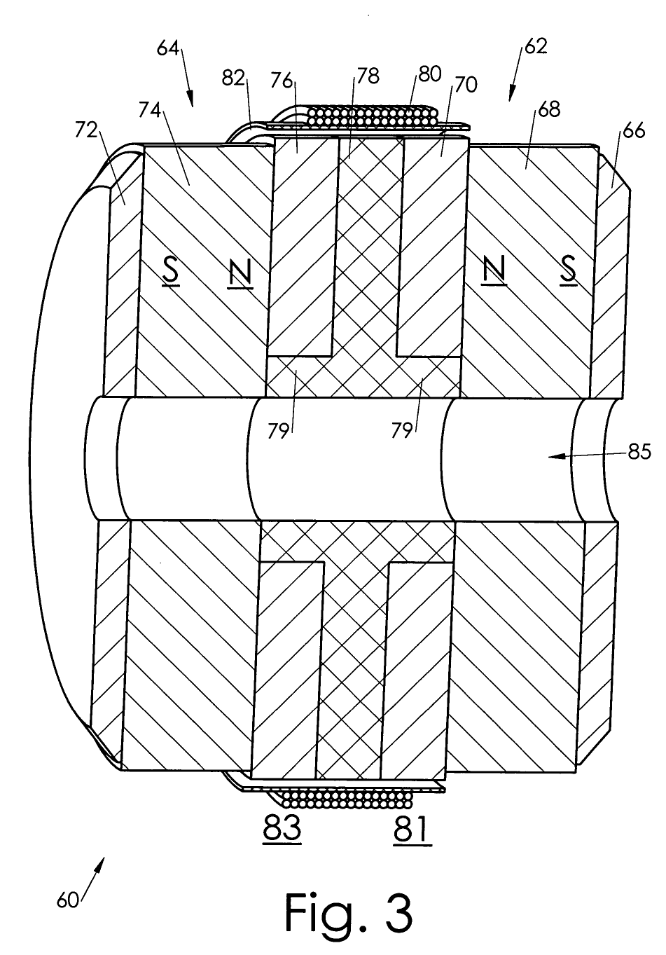

FIG. 3 illustrates a motor structure 60 according to one embodiment of this invention. The motor structure includes a pair of air-return magnet-plate assemblies, including a lower magnet-plate assembly 62 and an upper magnet-plate assembly 64. The lower assembly includes a lower end plate 66, an axially-charged lower magnet 68 magnetically coupled to the end plate, and a lower top plate 70 magnetically coupled to the lower magnet. The upper assembly includes an upper end plate 72, an axially-charged upper magnet 74 magnetically coupled to the upper end plate, and an upper top plate 76 magnetically coupled to the upper magnet. The upper magnet and the lower magnet are axially charged in opposite directions, preferably prior to assembly of the motor structure. The assemblies are coupled to opposite sides of a non-magnetically conductive spacer 78, such as an aluminum disc. The outer surfaces of the upper and lower top plates define regions of concentrated magnetic flux 81, 83. The magnetic flux returns to the outer ends of the motor via leakage paths through the surrounding air space.

The aluminum spacer provides axial separation between the two high-flux regions. As taught in the U.S. Pat. No. 6,917,690, a voice coil 80 extends from the axial midpoint of one high-flux region to the axial midpoint of the other. The voice coil is wound about a bobbin 82 which can in some applications be not much taller than the voice coil. As the voice coil moves in one direction, it leaves one high-flux region at the same rate that it enters the other, and thereby maintains a constant BL. The total linear Xmax (one-way, or center to one end) is equal to the thickness of the aluminum spacer plus the thickness of one top plate.

In one embodiment, as shown, the top plates have an inner diameter larger than that of the magnets, to increase the reluctance of the flux leakage short circuit path through the axial hole of each respective magnet. In such embodiments, the non-ferrous spacer 78 may include axial protrusions 79 which extend axially within the inner diameters of the top plates, to center the top plates and to increase thermal transfer through the spacer (which will gather heat from the voice coil region and conduct it to the lower temperature air traveling through the motor's axial vent hole 85. In another embodiment, the top plates, end plates, magnets, and spacer may each be a solid disc.

In other embodiments, each of the ring magnets may be replaced with a set of disc or segment shaped magnets. In some such embodiments, these smaller magnets may be spaced apart to permit air flow between them, further improving the cooling of the motor.

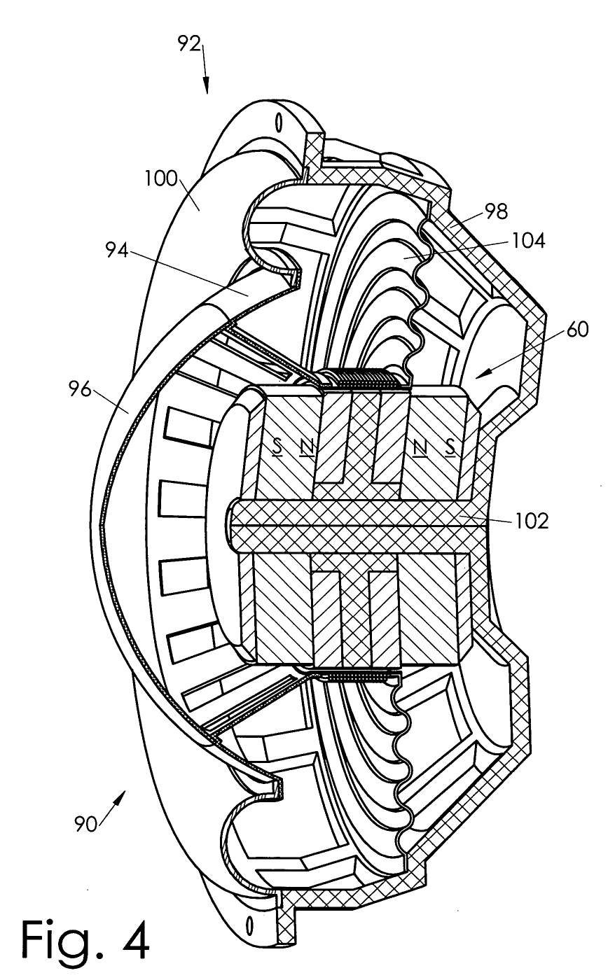

FIG. 4 illustrates an electromagnetic transducer 90 according to one embodiment of this invention. The transducer includes a diaphragm assembly 92 coupled to the motor structure 60 of FIG. 3. The diaphragm assembly includes a diaphragm 94, with dust cap 96, coupled to a frame 98 by a surround 100. The lower end plate of the motor is coupled to the frame. The frame may be made of any suitable material, such as forged aluminum, plastic, or what have you. In some. embodiments, the frame includes an axial projection 102 which retains and centers the motor. The bobbin is coupled to the frame by a spider 104. In one embodiment, as shown, the upper end of the bobbin is coupled to the diaphragm, and the lower end of the bobbin is coupled to the spider. In a conventional motor, the spider could not be coupled at this location, because the external motor components would interfere. However, the use of the air return path geometry enables it, facilitating a greatly shortened bobbin, a significantly thinner transducer, and, particularly when the spider is coupled to the lower end of the bobbin, increased mechanical stability resulting in greater resistance to rocking modes.

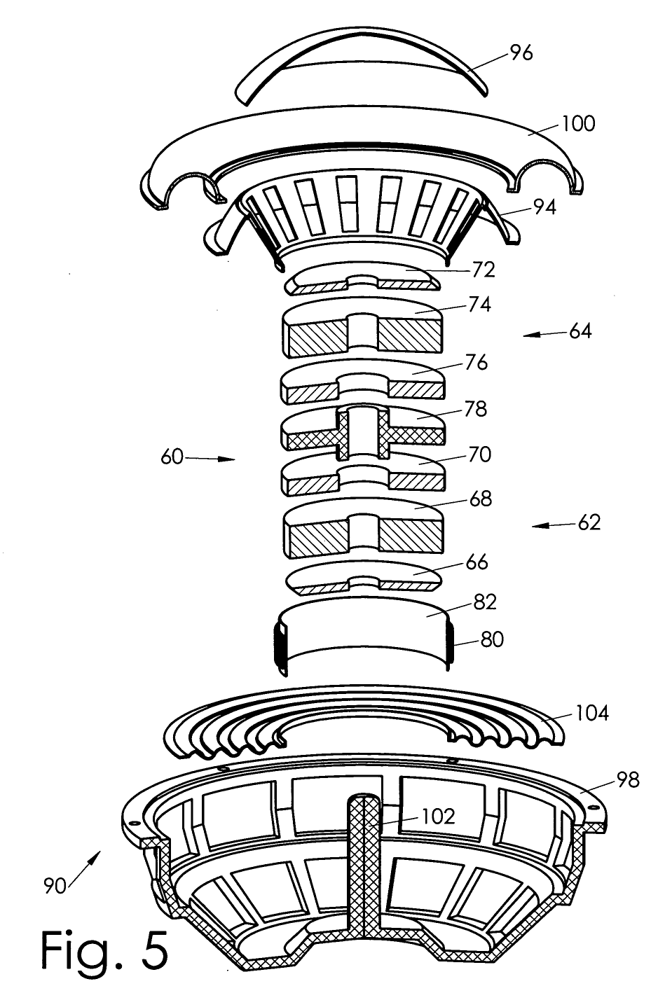

FIG. 5 illustrates the electromagnetic transducer 90 of FIG. 4 in a cross-sectioned exploded view, and may be used to explain the method of assembling the transducer. The end plate 66, magnet 68, and top plate 70 of the lower magnet-plate assembly 62 are coupled together. The magnet may be pre-charged, or it may be charged after the lower magnet-plate assembly is coupled together. Similarly, the end plate 72, magnet 74, and top plate 76 of the upper magnet-plate assembly 64 are coupled together, with the magnet being charged either before or after assembly. In some embodiments, as shown, the upper and lower magnet-plate assemblies are made with identical components.

The lower magnet-plate assembly is coupled to the basket 98, such as by being slid or threaded onto the optional aluminum post 102. The aluminum spacer 78 is then mounted on top of the lower magnet-plate assembly. The upper magnet-plate assembly is flipped upside-down with respect to the lower magnet-plate assembly, and is mounted on top of the aluminum spacer, such as by being slid or threaded onto the aluminum post. Adhesives may be used in coupling the various components together. The motor structure 60 is then complete.

The voice coil 80 is wound onto the bobbin 82, and the upper end of the bobbin is coupled to the cone or diaphragm 94 such as by an adhesive. The spider 104 is coupled to the lower end of the bobbin, again such as by an adhesive. Alternatively, the spider may be coupled to the upper end of the bobbin with the cone, or the cone may be coupled to the lower end of the bobbin with the spider. The surround 100 is coupled to the cone, such as with an adhesive. A centering jig or voice coil gauge (not shown) is used to hold the bobbin in a correct radial alignment about the motor structure, and while it is in place, the spider and the surround are coupled to the frame 98, such as by an adhesive. After the adhesive cures and the spider and surround are permanently affixed to the frame with the bobbin centered around the motor, the jig is removed, and then the dust cap 96 is coupled to the diaphragm.

During operation of the transducer, the aluminum spacer acts as a shorting ring and also provides a thermal path to the centering post and basket, thereby both reducing heating of the motor and extracting heat from the transducer.

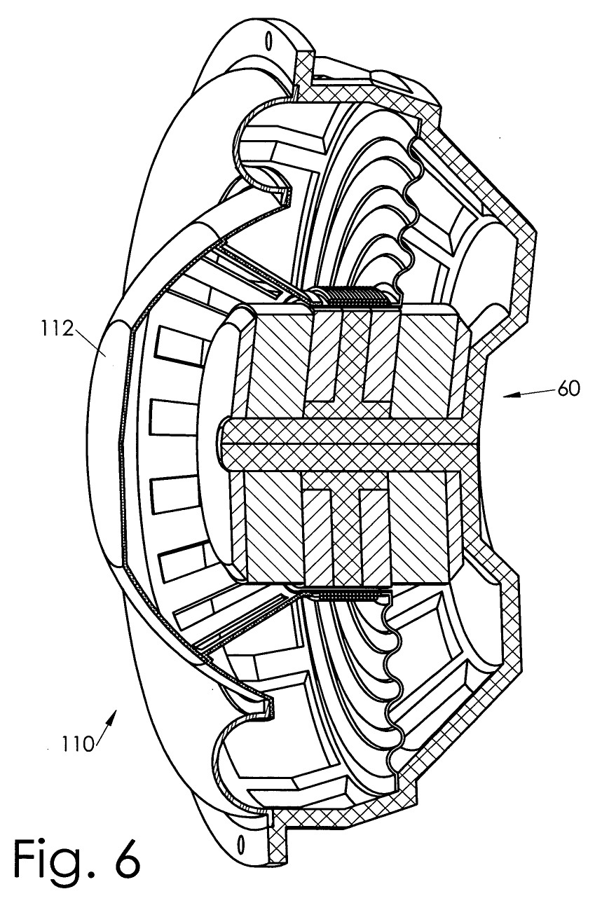

FIG. 6 illustrates another embodiment of an electromagnetic transducer 110 which uses the motor 60 and whose thickness is further reduced by the use of a flattened dust cap 112.

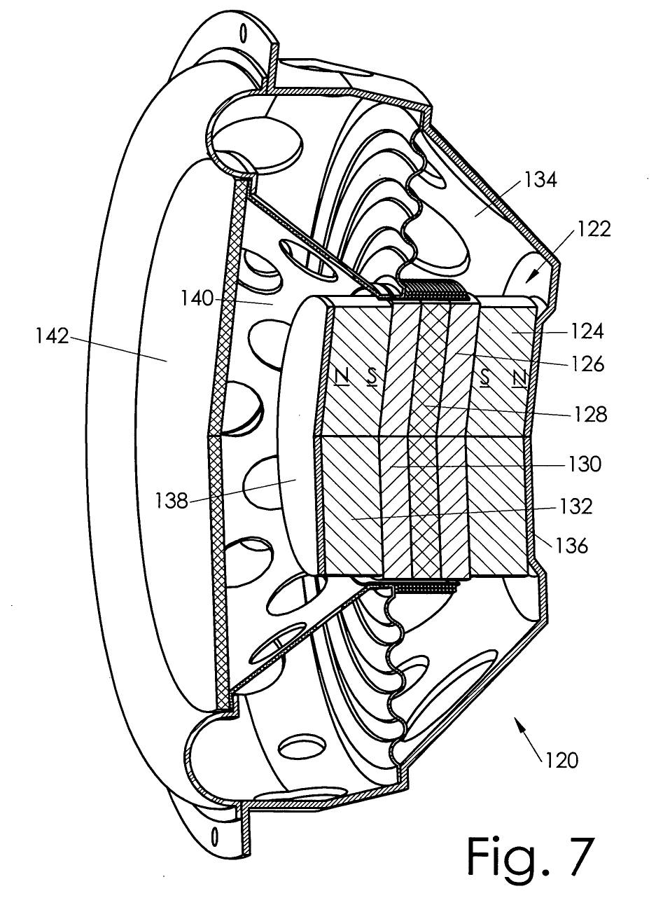

FIG. 7 illustrates another embodiment of an electromagnetic transducer 120 according to this invention. The transducer uses a motor 122 including a lower magnet 124, a lower top plate 126, an aluminum spacer 128, an upper top plate 130, and an upper magnet 132 coupled together. The magnets are oppositely polarized, as shown.

The transducer includes a magnetically-conductive frame 134, such as one stamped from steel. The lower magnet is magnetically coupled to a back plate portion 136 of the frame. The frame helps gather magnetic flux, reducing the reluctance of the return path to the lower magnet. The motor may optionally include a steel end plate 138 of any suitable size and shape to lower the reluctance of the flux return path to the upper magnet, helping to equalize the flux density of the respective high-flux regions adjacent the outer edges of the two top plates.

The transducer includes a cone 140 and a flat piston dust cap 142.

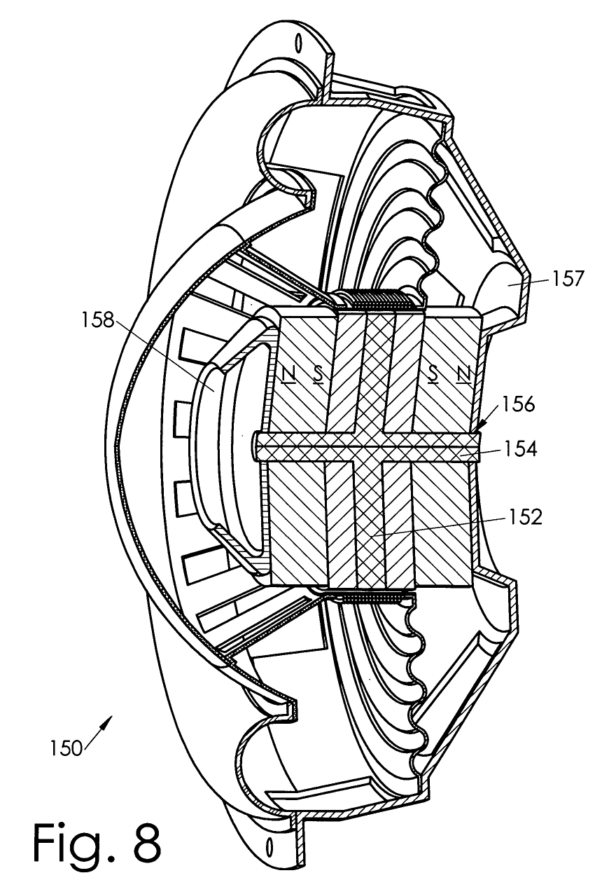

FIG. 8 illustrates an electromagnetic transducer 150 according to another embodiment of this invention. The motor includes an aluminum spacer 152 having an axial portion 154 extending through the motor to align the motor components. Optionally, the axial portion extends out the lower end of the motor and engages a hole 156 in the back plate of the frame 157, aligning and retaining the motor with respect to the frame. Optionally, the motor may include a steel end plate 158 of any shape designed to improve flux gathering while avoiding being struck by the cone or dust cap.

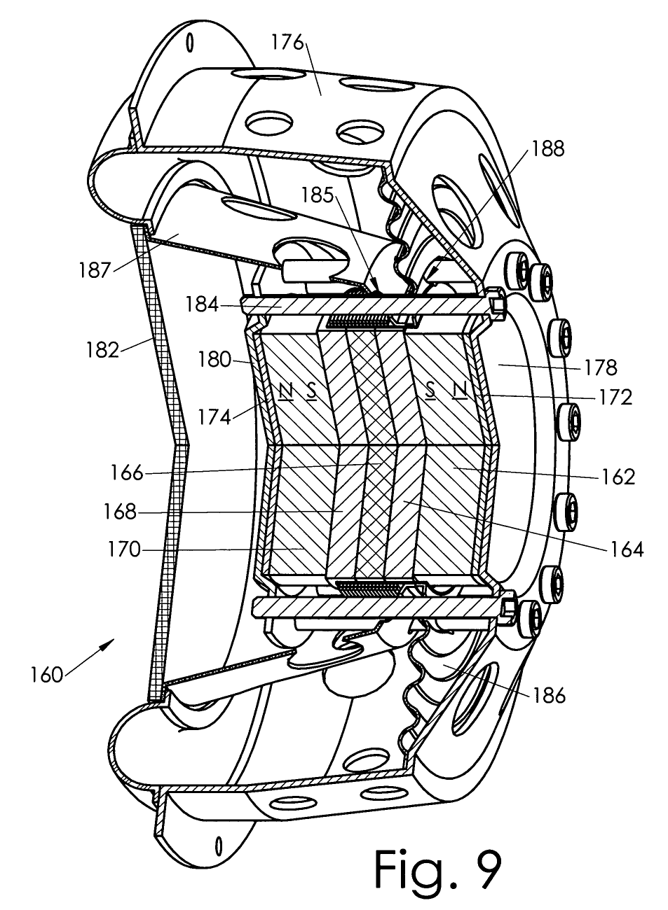

FIG. 9 illustrates an electromagnetic transducer 160 according to yet another embodiment of this invention. The transducer includes a motor having a lower magnet 162, a lower top plate 164, a non-magnetically conductive spacer 166, an upper top plate 168, and an upper magnet 170 coupled together, with the axially-charged magnets oppositely oriented. The motor optionally also includes end plates 172, 174. The transducer includes a stamped steel frame 176 having a back plate 178 to which the lower end of the motor is coupled. The steel frame itself serves to gather flux for a reduced-reluctance return path to the lower magnet.

A stamped steel upper retention plate 180 is coupled to the upper end of the motor, and serves to gather flux for a reduced-reluctance return path to the upper magnet. Optionally, the retention plate may be shaped to have a lowered profile as shown, permitting the flat piston dust cap 182 to be mounted even closer to the motor. Alternatively, the retention plate may be shaped to mirror the shape of some portion of the frame near the rear of the motor, to provide a flux gathering member as equivalent as possible to the frame, to improve symmetry in the flux density of the two respective high-flux regions.

The retention plate may also serve to retain the motor and fasten it to the frame, with the addition of retention bolts 184. The retention bolts extend through the frame and thread into the retention plate, or into nuts (not shown) on the upper side of the retention plate; alternatively, they could, of course, go the other direction. The spider 186 and cone 187 are adapted with a corresponding set of holes 188, 185 through which the retention bolts pass. The retention bolts may advantageously be made of steel, such that they provide an even greater reduction in the reluctance of the flux return paths to the magnets. As such, it is desirable to position the retention bolts as close as possible to the voice coil assembly, with a suitable safety margin to avoid strikes and rubbing. The number of retention bolts can be selected according to the needs of the particular application at hand; the more bolts there are, the more holes there will be through the cone and the spider, the weaker the cone and the spider will be, but the lower the reluctance of the return paths will be.

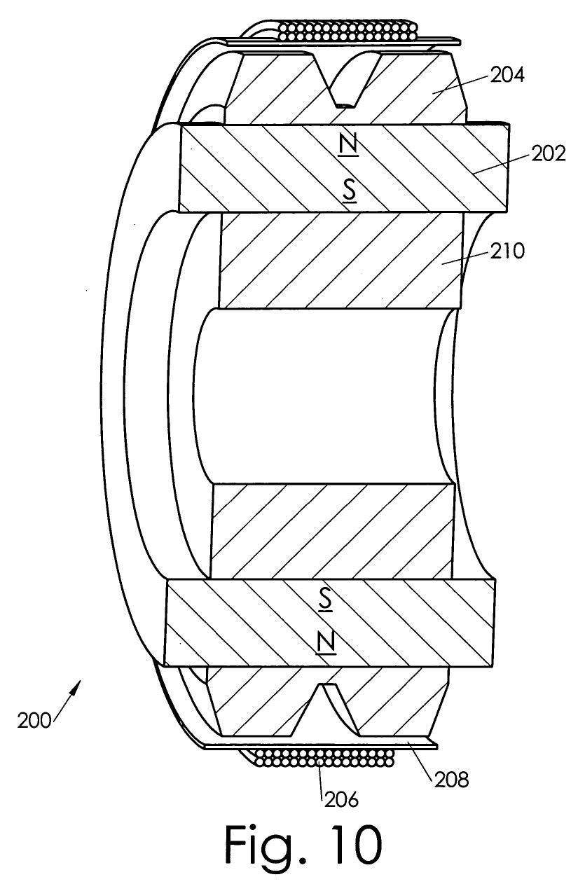

FIG. 10 illustrates a motor 200 according to another embodiment of this invention. The motor includes a radially-charged (rather than axially-charged) magnet 202 and a flux focusing ring 204 which defines two high-flux regions and which is made of e.g. steel. Alternatively, the radially-charged magnet itself could have an outer surface shaped to define the two high-flux regions. The motor further includes a voice coil 206 wound onto a bobbin 208 and positioned astride the two high-flux regions. Optionally, the motor includes a steel core 210 which lowers the reluctance of the return paths from the high flux density regions back to the inner surface of the magnet.

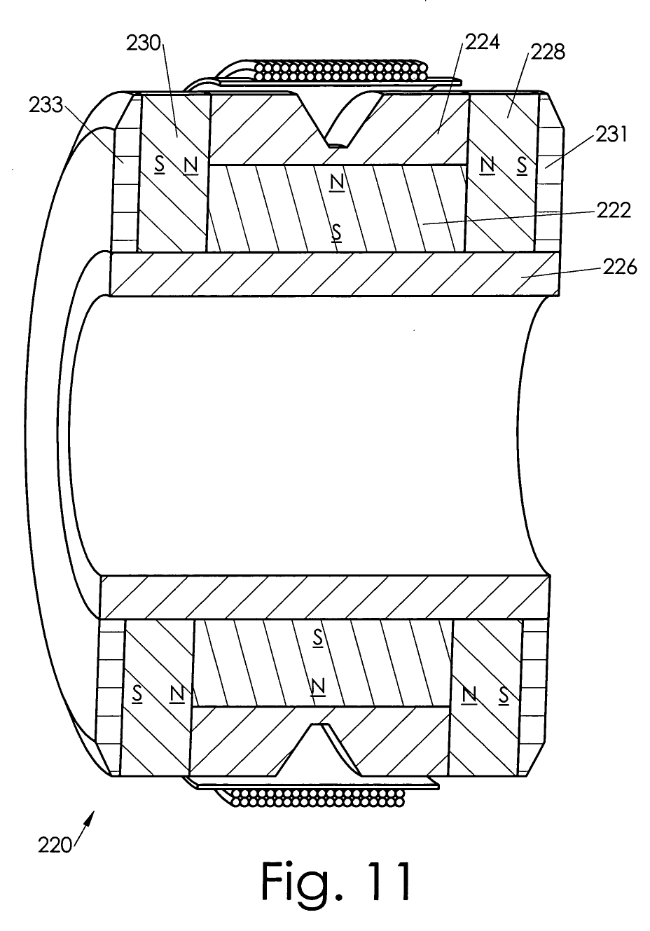

FIG. 11 illustrates a motor 220 according to yet another embodiment of this invention. The motor includes a radially-charged magnet 222, flux-focusing ring 224, and an inner steel core 226. It further includes at least one axially-charged ring magnet 228 oriented such that it has the same pole facing the radially-charged magnet and the focusing ring that is on the outside of the radially-charged magnet, as shown. It preferentially also includes a second axially-charged ring magnet 230 oriented with that same pole facing the radially-charged magnet and the focusing ring or, in other words, in the mirror image of the first ring magnet. Optionally, but beneficially, the inner core extends through inner diameters of the ring magnets.

The ring magnets not only provide additional magnetic flux into the focusing ring, they also prevent flux leakage out the lower and upper ends of the focusing ring. If the ring magnets were not present, most of the flux from the radially-charged magnet would enter the inner surface of the focusing ring and then pass axially out the ends of the focusing ring, taking a short circuit back to the inner core and magnet. With the addition of the ring magnets, virtually all of the flux from the radially-charged magnet (and the ring magnets) is force to exit the focusing ring radially, through the desired regions of high flux density. Furthermore, the upper surface/pole of the upper ring magnet, and the lower surface/pole of the lower ring magnet (that is, the surfaces at the ends of the motor) serve as much shorter return paths for the flux, which does not all need to travel through air to the inner core.

Because magnetic flux must travel perpendicularly (normal to the surface) at any reluctance transition boundary—such as the boundary between the focusing ring and the air—it is highly desirable to cover all back and end focusing ring surfaces with magnets, such that the only effective exit path is through the desired surfaces at the outer diameter of the focusing ring. This forces essentially all of the flux to travel radially out through the desired high flux regions where the voice coil operates.

It is further advantageous to provide steel end plates 231, 233 magnetically coupled to the end poles of the ring magnets opposite the focusing ring and the radially-charged magnet, to help gather and steer magnetic flux.

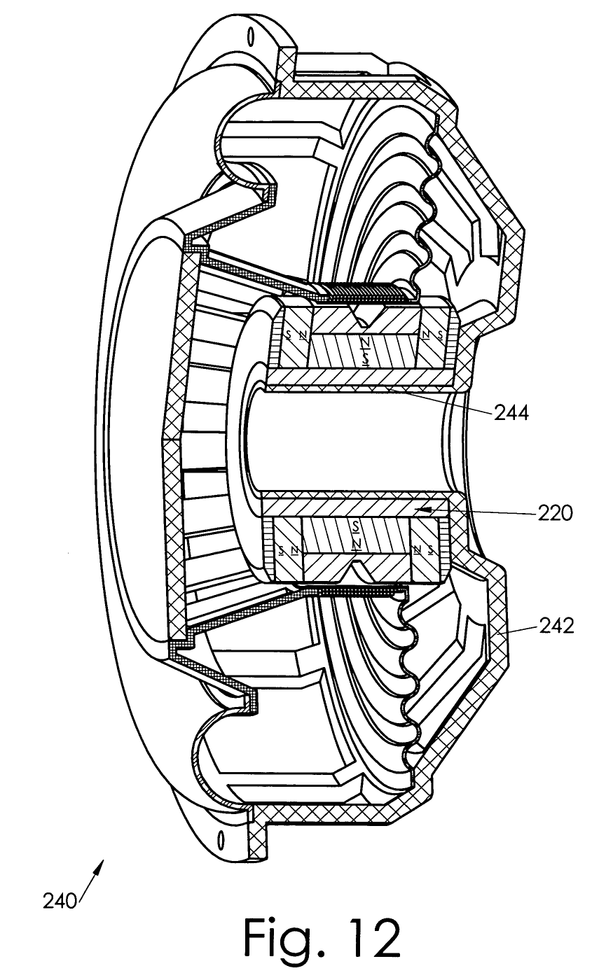

FIG. 12 illustrates an electromagnetic transducer 240 using the motor 220. Optionally, the frame 242 may include a centering post 244 onto which the motor is mounted. The centering post may be ventilated, as shown.

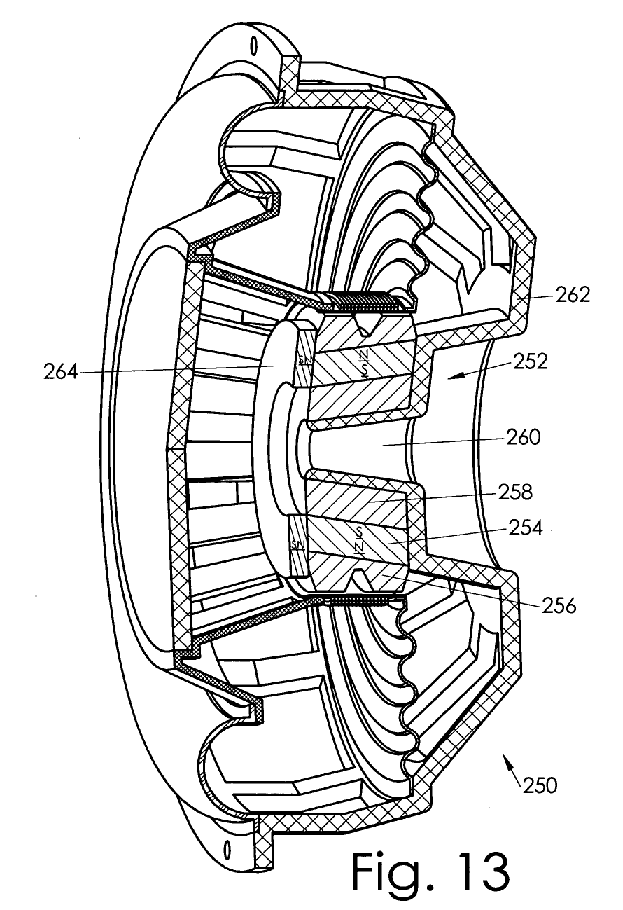

FIG. 13 illustrates a similar electromagnetic transducer 250 which includes a motor 252 using a conical radially-charged or semi-radially-charged magnet 254, a flux focusing ring 256 having a conical inner surface shaped to mate with the conical outer surface of the magnet, and a conical steel core 258 having an outer surface shaped to mate with the inner surface of the magnet and an inner surface shaped to mate with a conical centering post 260 of the frame 262. The conical shapes ease assembly and reduce sensitivity to manufacturing tolerances. Typically, the components will be designed to have some room for axial positioning differences due to such tolerances, rather than the tightly-mated configuration which is shown here for convenience.

Because of the conical shape of the magnet, the upper end of the motor includes less magnet surface area than the lower end of the motor, and the upper end of the focusing ring has more (flux leaking) surface area than the lower end of the focusing ring. Therefore, the motor may optionally and advantageously also include an axially-charged magnet 264 coupled at the upper end of the motor with the same pole facing the conical magnet as the conical magnet has facing outward, to reduce flux leakage, increase flux density, and increase flux symmetry in the motor.

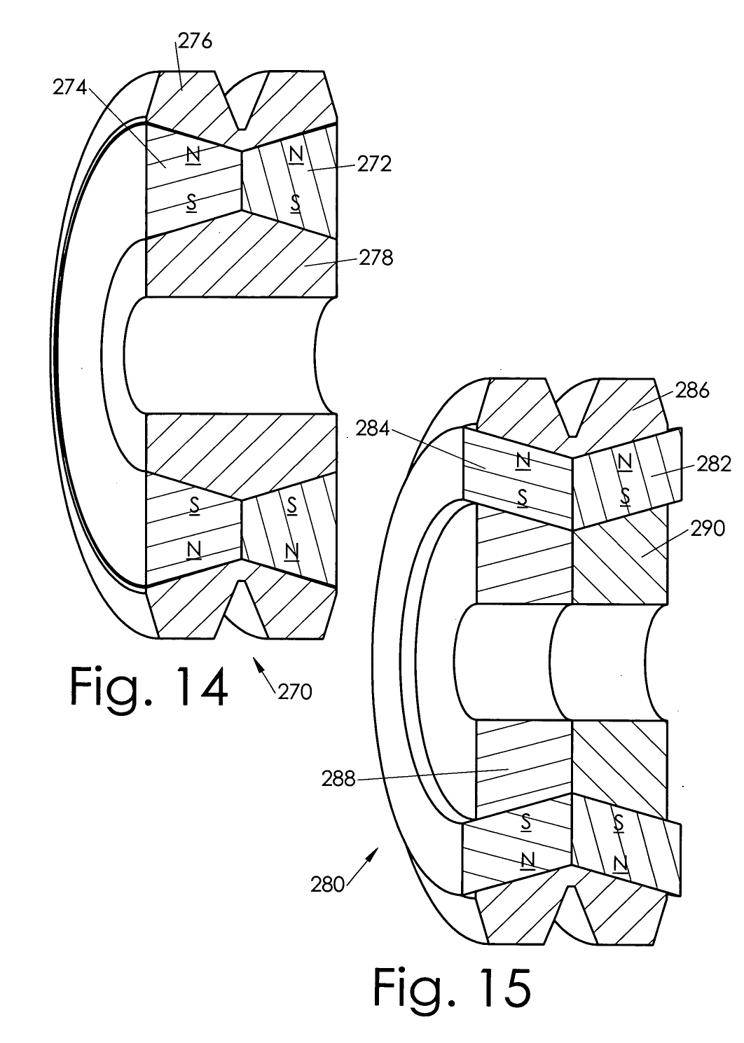

FIG. 14 illustrates still another embodiment of a radially-charged magnet motor 270. The motor includes a pair of radially-charged magnets 272, 274 coupled from opposites sides to a dual-gap focusing ring 276 and a steel core 278. The focusing ring has a dual-conical inner surface, and the core has a dual-conical outer surface that may optionally be cut at the same angle as the angle of the focusing ring's inner surface. The magnets may advantageously be mirror images of each other, and thus the magnetic flux density in the two high-flux regions will be equal, and a single sku of magnet may be stocked by the manufacturer.

FIG. 15 illustrates yet another embodiment of a radially-charged motor 280 using a pair of semi-radially-charged conical magnets 282, 284, a dual-gap focusing ring 286, and a pair of steel cores 288, 290. The pair of magnets and the pair of cores may advantageously be of the same skus.

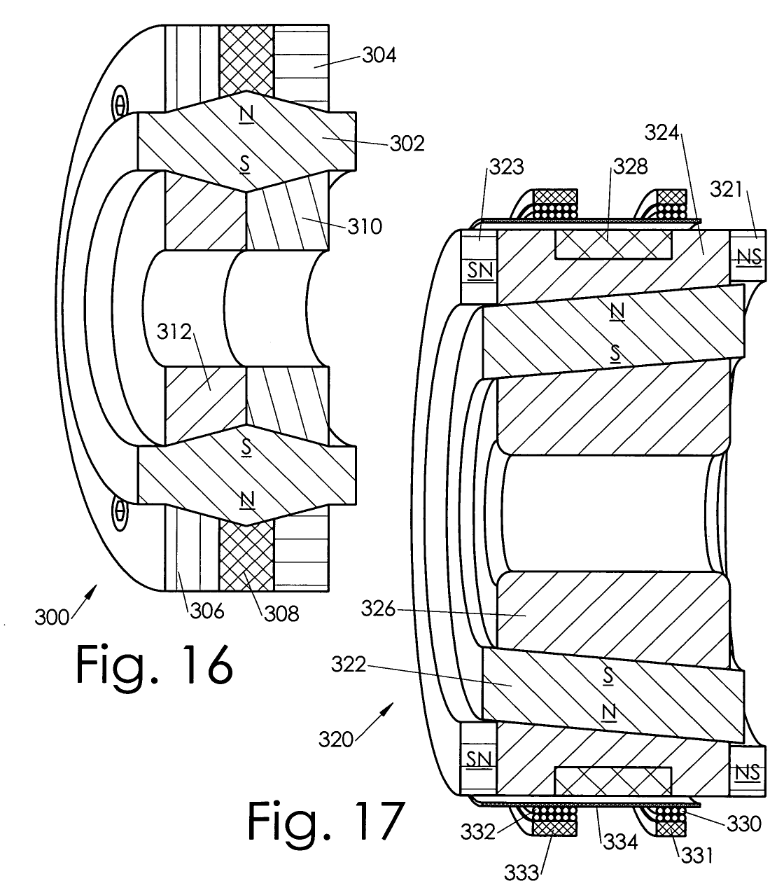

FIG. 16 illustrates another motor 300 using a radially-charged magnet 302 having a double-conical cross-sectional shape that is tapered away from its center, essentially forming a conical lower side and a conical upper side. A lower flux focusing ring 304 and an upper flux focusing ring 306 are magnetically coupled to the magnet, having inner surfaces shaped to mate with the respective conical outer surfaces of the magnet. An aluminum shorting ring 308 fills in the space between the magnetic flux focusing rings, and serves to sink eddy currents, reduce heating of the motor, and reduce flux modulation. A pair of optional steel cores 310, 312 have outer surfaces shaped to mate with the inner conical surfaces of the magnet.

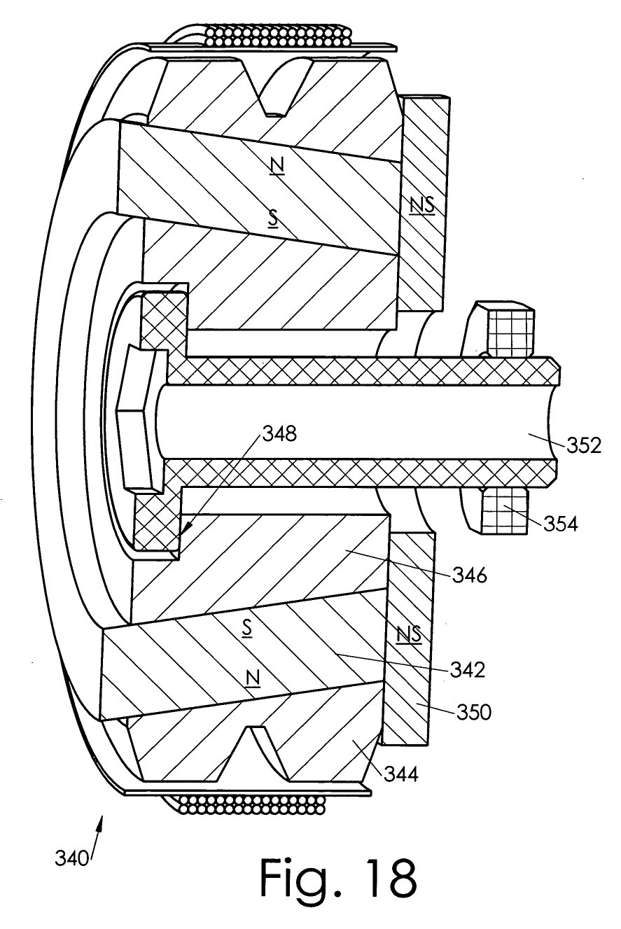

FIG. 17 illustrates yet another motor 320 having a semi-radially-charged conical magnet 322, a dual-gap flux focusing ring 324, and a steel core 326. An optional shorting ring 328 is formed in the groove between the two flux focusing portions of the focusing ring. If the focusing ring is a monolithic single piece, the shorting ring may be formed e.g. of electrically conductive metallic epoxy which is poured in place in a mold and cured, or by wrapping layers of non-insulated metal wire or sheeting, or by welding a C-shaped split ring in situ, or what have you.

The motor further includes a pair of axially-charged concentrating magnets 321, 323 magnetically coupled to the ends of the focusing ring, with the polarity opposite each other as shown. Because the larger diameter end of the conical magnet provides greater flux-emitting surface area than does the smaller diameter end, the concentrating magnet 323 at the smaller diameter end of the conical magnet may advantageously have a larger flux-emitting surface area than the other concentrating magnet, to more closely equalize the total amount of magnetic flux generated in the two halves of the focusing ring.

The motor includes a pair of voice coils 330, 332 wound onto a bobbin 334. The voice coils may be wound in the same direction, or they may be wound in opposite directions and fed opposite-phase signals. In some embodiments, as shown, the voice coils may be of unequal axial height, with a greater number of windings (for greater L) in the high flux region at the smaller (and thus weaker) end of the conical magnet, to achieve more equal BL between the two voice coils, especially if the concentrating magnets are absent or are unable to sufficiently equalize the flux density in the two high flux regions.

To lower reluctance of the magnetic circuit, and to improve focusing of the magnetic flux through the voice coils, the voice coil assembly may be provided with a pair of steel rings 33 1, 333 disposed radially outside the voice coils. Alternatively, in some geometries, these rings could themselves be small radially-charged ring magnets. The rings may be coupled to the bobbin and/or the voice coils with e.g. high temperature tolerant epoxy. These steel rings may be especially suitable for use in subwoofer speakers, in which the mass of the diaphragm assembly is often deliberately increased by the designer to tune various operating characteristics of the subwoofer.

FIG. 18 illustrates another motor 340 having a semi-radially-charged conical magnet 342 whose small diameter end is at the lower end of the motor. The motor also includes a focusing ring 344, and a steel core 346 which includes a recess 348. An axially charged ring magnet 350 is coupled to the lower end of the motor, with its same pole facing the motor as the radially-charged magnet has facing outward. A bolt 352 passes through the motor and engages the recess of the core. A nut 354 mates with the bolt.

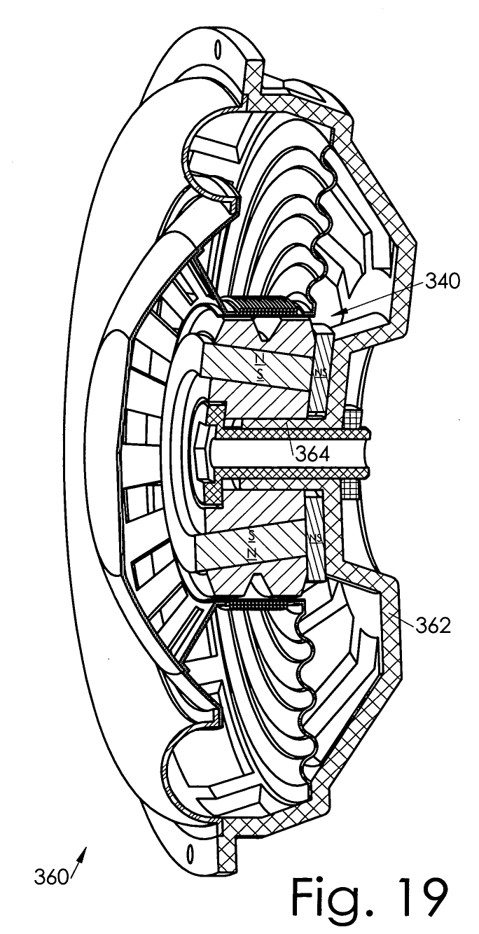

FIG. 19 illustrates an electromagnetic transducer 360 in which the mounting of the motor 340 to the basket 362 serves to keep the motor components in correct and tight axial alignment. During assembly of the motor, the conical magnet is inserted into the focusing ring from the upper end, and the core is inserted onto the conical magnet from the upper end. Then, the motor is mounted onto an optional mounting post 364 of the basket. The bolt extends through this post, and the nut is threaded onto the bolt from the lower side of the basket. As the nut tightens the bolt downward, the bolt tightens against the steel core, drawing it toward the basket. The outwardly flaring shape of the motor components prevents each component from shifting farther outward than the next inner component to which it is coupled.

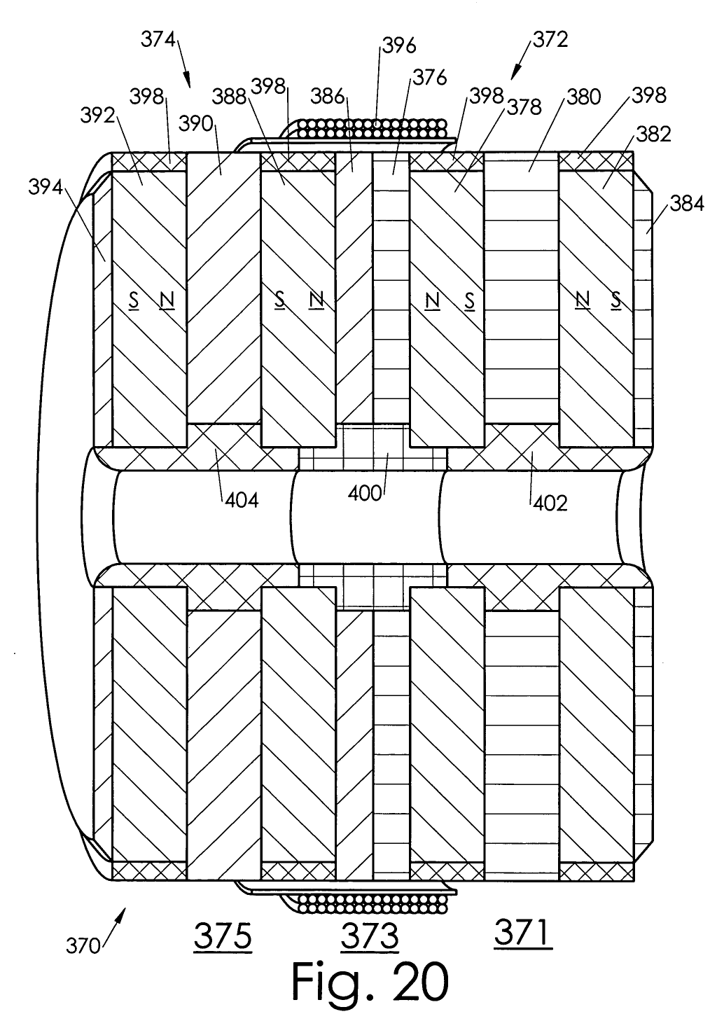

FIG. 20 illustrates a motor 370 providing three regions of high flux density 371, 373, 375 in which the magnetic flux travels in the same radial direction. The motor may optionally be constructed as two substantially mirror image halves 372, 374. The lower half includes a half-thickness center top plate 376, an axially charged magnet 378, a lower top plate 380, an axially charged magnet 382, and an optional end plate 384 magnetically coupled in a stack. The upper half includes a half-thickness center top plate 386, an axially charged magnet 388, an upper top plate 390, an axially charged magnet 392, and an optional end plate 394 magnetically coupled in a stack.

In each half, the magnets are charged in the same direction. When the two halves are coupled together in mirror image fashion, the lower half s magnets are oppositely polarized with respect to the upper half s magnets.

The two half-thickness center top plates are butted together and, together, form a full-thickness center top plate. A voice coil 396 is centered at the center top plate. The magnets and top plates (with the two half-thickness center top plates considered as one full-thickness center top plate) each have the same thickness, e.g. 8 mm. The voice coil's axial height is twice this thickness, e.g. 16 mm, such that it extends from the center of the magnet 378 to the center of the magnet 388. Thus, as the voice coil travels, there is always e.g. 8 mm of voice coil actively engaged with some region(s) of high flux density, as the voice coil is handed off from one such region to the next. The total geometrically linear Xmax end-to-end travel is 5× the top plate thickness—in this example 40 mm, or 20 mm one-way.

In order to have an equal flux density at each of the high flux regions, the outer magnets 382, 392 should be stronger than the inner magnets 378, 388. Note that the center high flux region 373 adjacent the center top plate 376, 386 is receiving magnetic flux from both magnets 378 and 388, but, for example, the lower top plate 380 is receiving flux from only one magnet 382 and, additionally, some of that magnet's flux will pass through the lower top plate into the magnet 378. In one embodiment, the center magnets 378, 388 are ceramic magnets and the outer magnets 382, 392 are neodymium magnets.

The motor may optionally include shorting rings 398 and/or non-magnetic centering fixtures 400, 402, 404 as shown.

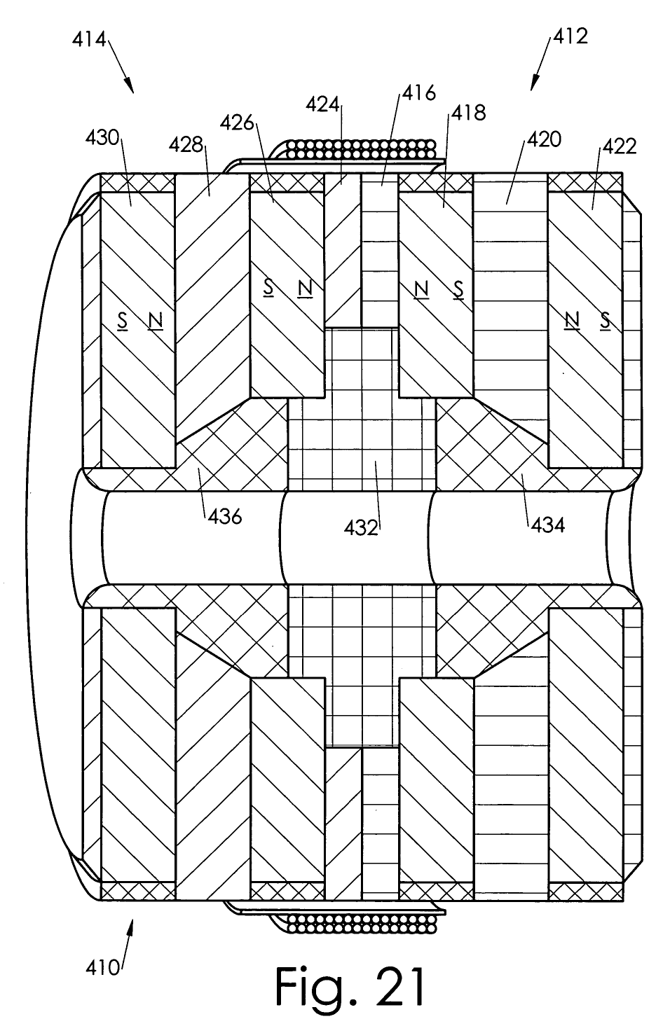

FIG. 21 illustrates a motor 410 similar to that of FIG. 20, including a lower half 412 and an upper half 414. The lower half includes a half-thickness center top plate 416 which has a smaller surface area than the lower top plate 420 and a center magnet 418 which has a smaller surface area than an outer magnet 422. The upper half includes a half-thickness center top plate 424, which has a smaller surface area than the upper top plate 428 and a center magnet 426 which has a smaller surface area than an outer magnet 430.

In one embodiment, the upper and lower top plates 428, 420 are beveled such that they have more surface area in contact with their larger magnet than with their smaller magnet. In one embodiment, all four magnets are neodymium magnets. The motor may optionally include shaped appropriately centering fixtures 432, 434, 436.

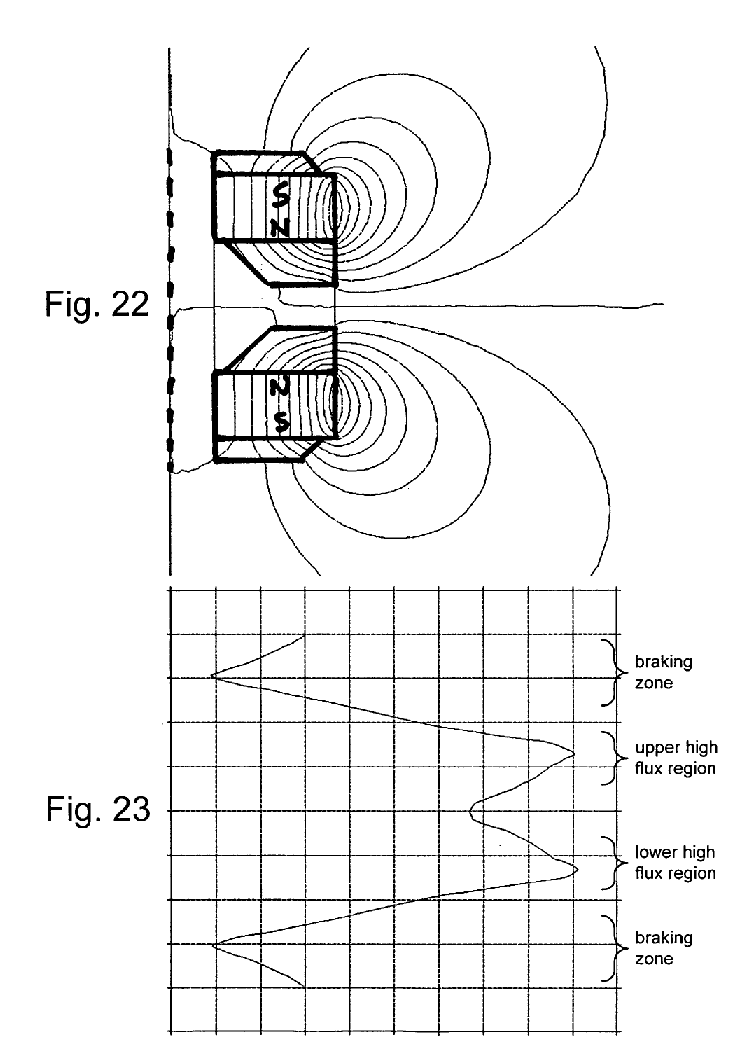

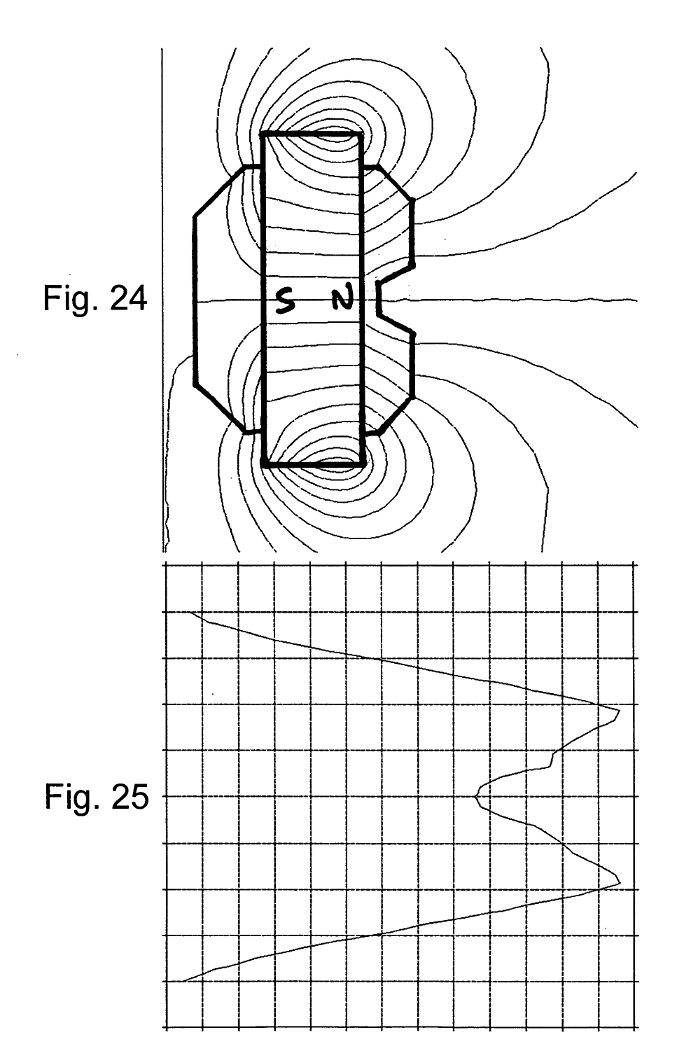

FIG. 22 is a computer model generated flux line diagram for the motor structure shown, including oppositely oriented axially-charged ring magnets with upper and lower top plates disposed between them on their facing surfaces (North poles) and a pair of end plates disposed on their end surfaces (South poles). The motor is modeled as an axisymmetric revolve about the axis (shown as a heavy dashed line). The flux lines demonstrate the direction of magnetic flux flow, and their proximity suggests the corresponding magnetic flux density at any particular location.

FIG. 23 is a magnetic flux density chart from the model of FIG. 22, and is not shown at exactly the same scale. The two regions of high flux density are very distinct, and are separated by a region of somewhat lower flux. Also notable are two magnetic braking zones, where the magnetic flux travels in the opposite direction, near the extreme ends of the motor. When the voice coil enters one of these regions, the oppositely oriented magnetic flux will accelerate the voice coil back toward the center of the motor, preventing overshoot.

FIG. 24 is a computer model generated flux line diagram for the motor structure shown, including a radially-charged magnet, a steel focusing ring shaped to provide two high flux density regions, and a steel core. In many geometries, it has been observed that, if the focusing ring is present, the addition of the steel core does not significantly improve the flux density in the operative regions.

FIG. 25 is a magnetic flux density chart from the model of FIG. 24, and is oriented as explained above.

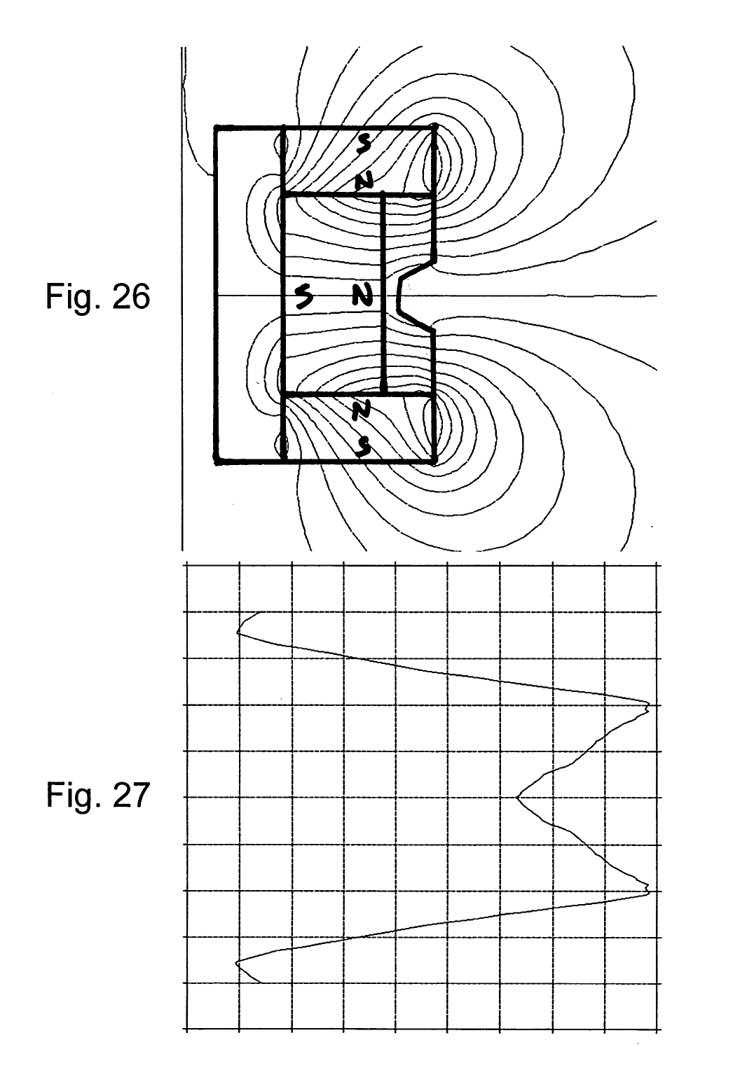

FIG. 26 is a computer model generated flux line diagram for the motor structure shown, including a radially-charged magnet, a pair of axially-charged concentrating magnets, a steel focusing ring, and a steel core.

FIG. 27 is a magnetic flux density chart from the model of FIG. 26. The motor of FIG. 26 produces significantly higher magnetic flux density than does the motor of FIG. 24. FIG. 27 and FIG. 25 are not drawn to the same scale.

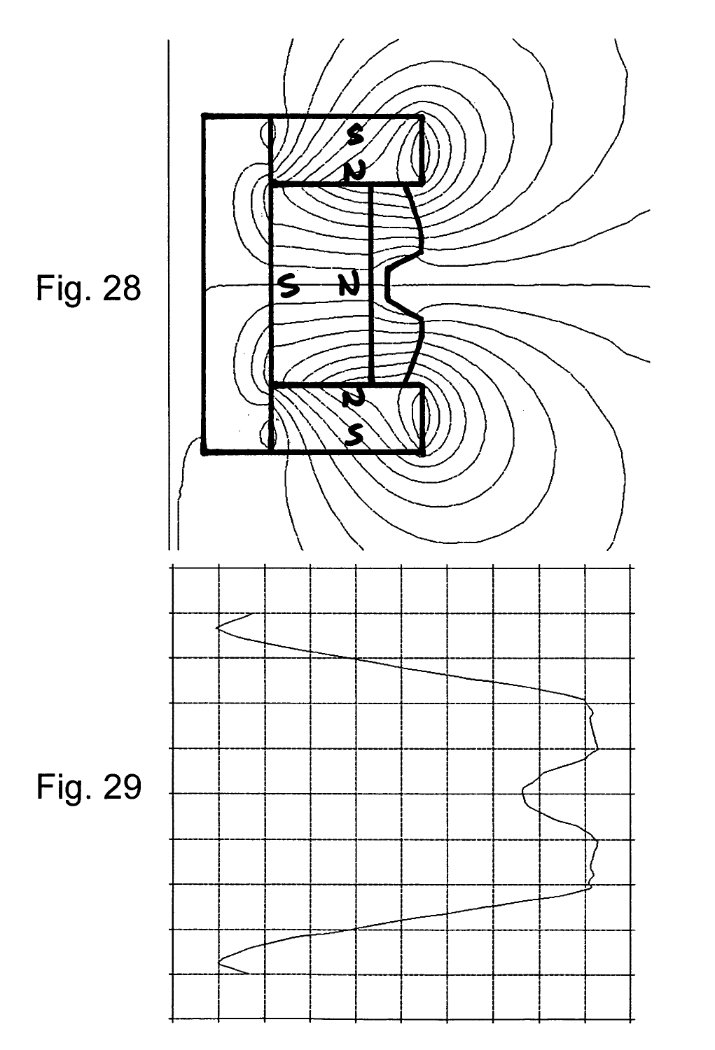

FIG. 28 is a computer model generated flux line diagram for the motor structure shown, including a radially-charged magnet, a pair of axially-charged concentrating magnets, a steel focusing ring having a tapered outer surface, and a steel core.

FIG. 29 is a magnetic flux density chart from the model of FIG. 28. by comparing FIG. 29 to FIG. 27, the reader will readily appreciate the beneficial effect of tapering the outer surface of the focusing ring. The tapered shape significantly flattens the curve in each high flux region or, in other words, it improves the uniformity of the magnetic flux density over the height of each high flux region.

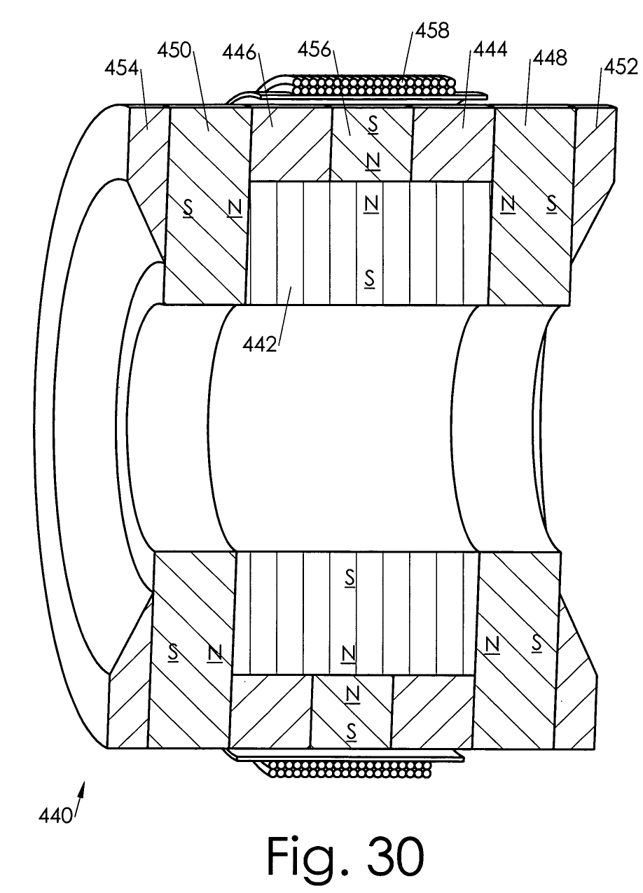

FIG. 30 illustrates a motor 440 according to yet another embodiment of this invention. The motor includes a primary radially-charged magnet 442, a pair of top plates 444, 446 having their inner surfaces magnetically coupled to the outer surface of the primary magnet, a pair of axially-charged concentrating magnets 448, 450 magnetically coupled to the ends of the primary magnet and the top plates, and a pair of end plates 452, 454 magnetically coupled to the end surfaces of the concentrating magnets.

The motor also includes a secondary radially-charged magnet 456 disposed between the top plates. The four magnets all have like poles facing the region where the two radially-charged magnets meet. That is, the two radially-charged magnets are oppositely charged, the two axially-charged magnets are oppositely charged, and the axially-charged magnets have the same pole facing toward the primary magnet as the two radially-charged magnets have facing each other.

A voice coil 458 is partially disposed within both of the high flux density regions 460, 462 just beyond the outer surfaces of the top plates. The voice coil may be of any suitable dual-gap configuration.

In one embodiment, the outer diameters of the concentrating magnets, the top plates, and the secondary magnet are substantially the same.

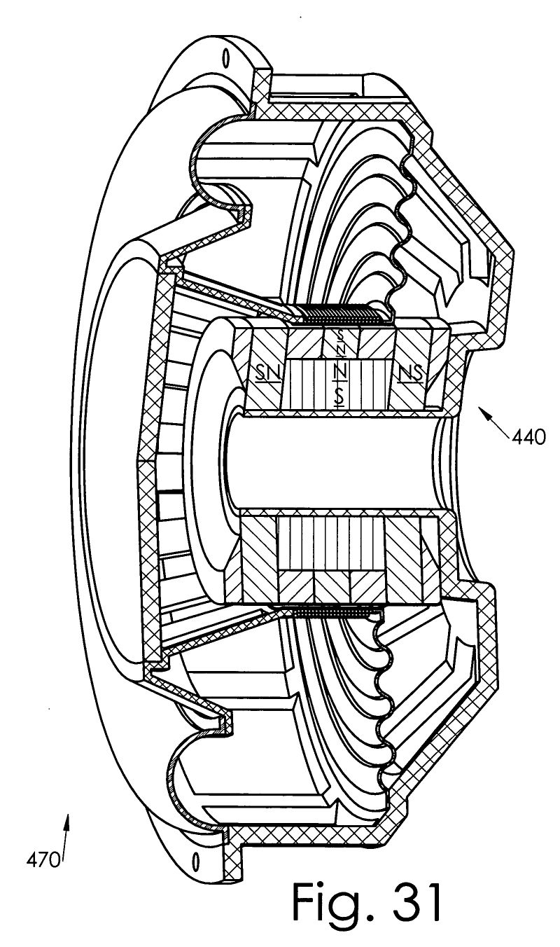

FIG. 31 illustrates an electromagnetic transducer 470 using the motor 440 of FIG. 30.

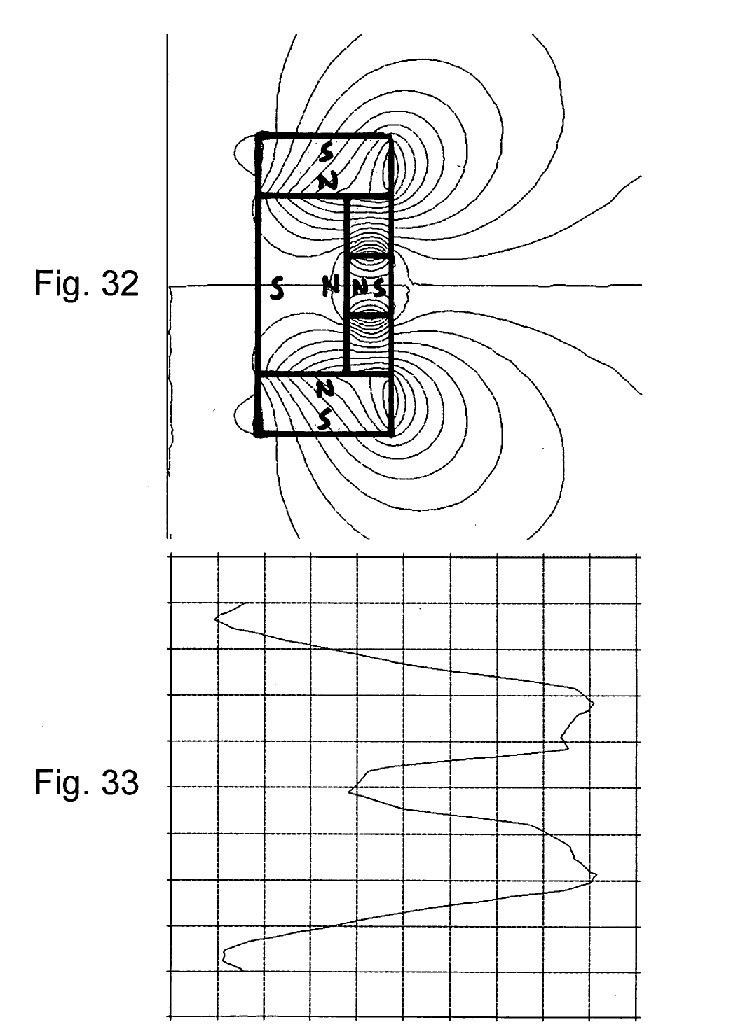

FIG. 32 is a computer model generated flux line diagram for a motor substantially similar to that of FIG. 30, except it lacks the optional steel end plates.

FIG. 33 is a magnetic flux density chart from the model of FIG. 32. It exhibits an extremely good wave form with crisp definition of the high flux region boundaries.

### Conclusion

When one component is said to be “adjacent” another component, it should not be interpreted to mean that there is absolutely nothing between the two components, only that they are in the order indicated.

The various features illustrated in the figures may be combined in many ways, and should not be interpreted as though limited to the specific embodiments in which they were explained and shown.

Although the radially charged versions of the transducers and motors are shown as having separate steel flux focusing rings, the invention can also be practiced using radially charged magnets which are, themselves, shaped to form the high flux regions without the need for a separate steel focusing ring. The illustration of the steel focusing rings should not be considered limiting on the scope of the invention, except where expressly so stated in the claims.

Those skilled in the art having the benefit of this disclosure will appreciate that many other variations from the foregoing description and drawings may be made within the scope of the present invention. Indeed, the invention is not limited to the details described above. Rather, it is the following claims including any amendments thereto that define the scope of the invention.

What is claimed is:

1. An electromagnetic transducer comprising:
(a) a motor structure including,
at least one permanent internal magnet, and
plate means magnetically coupled to the magnet for defining at an outer diameter thereof a first region of high flux density and a second region of high flux density separated by a center region of lower flux density,
wherein magnetic flux return paths from the regions of high flux density to the magnets are primarily via ambient air; and
(b) a diaphragm assembly including,
a diaphragm,
a bobbin coupled to the diaphragm and extending over the motor structure, and
a voice coil coupled to the bobbin and including first windings disposed within the first region of high flux density and second windings disposed within the second region of high flux density.

2. The electromagnetic transducer of claim 1 wherein the at least one permanent magnet comprises:
a lower axially-charged magnet having a first pole magnetically coupled to a lower side of the plate means; and
an upper axially-charged magnet having the first pole magnetically coupled to an upper side of the plate means;
such that like poles of the lower and upper magnets are facing each other.

3. The electromagnetic transducer of claim 1 wherein the at least one permanent magnet comprises:
a radially-charged primary magnet having an outer surface magnetically coupled to an inner surface of the plate means.

4. The electromagnetic transducer of claim 3 wherein the at least one permanent magnet further comprises:
a first axially-charged internal magnet disposed adjacent a first end of the plate means such that like poles of the radially-charged magnet and of the first axially-charged magnet are facing the plate means.

5. The electromagnetic transducer of claim 4 wherein the at least one permanent magnet further comprises:
a second axially-charged internal magnet disposed adjacent a second end of the plate means such that like poles of the radially-charged magnet and of the second axially-charged magnet are facing the plate means.

6. The electromagnetic transducer of claim 5 wherein:
the plate means comprises two steel top plates; and wherein the transducer further comprises
a secondary radially-charged magnet disposed between the top plates and having its polarity opposite that of the primary magnet.

7. The electromagnetic transducer of claim 3 wherein the radially-charged magnet comprises:
a conical magnet.

8. The electromagnetic transducer of claim 7 wherein:
an axially-charged internal magnet disposed adjacent a the plate means at a small end of the conical magnet such that like poles of the radially-charged magnet and of the axially-charged magnet are facing the plate means.

9. The electromagnetic transducer of claim 8 wherein:
a large end of the conical magnet is facing the diaphragm assembly; and
the motor assembly includes,
a frame,
an inner core disposed within the conical magnet, and
a bolt securing the inner core to the frame, whereby the motor structure is retained onto the frame.

10. The electromagnetic transducer of claim 1 wherein:
the motor structure includes substantially symmetrical, mirror image motor halves.

11. The electromagnetic transducer of claim 10 wherein:
at least one component of the motor structure has a double-conical shape.

12. An electromagnetic transducer comprising:
(a) a motor structure including,
a first axially-charged internal magnet,
a second axially-charged internal magnet having its polarity opposite that of the first magnet such that like poles of the first and second magnets are facing each other, and
plate means magnetically coupled between the first and second magnets for defining at an outer diameter thereof a first region of high flux density and a second region of high flux density separated by a center region of lower flux density,
wherein magnetic flux return paths from the regions of high flux density to the magnets are primarily via ambient air; and
(b) a diaphragm assembly including,
a diaphragm,
a bobbin coupled to the diaphragm and extending over the motor structure,
a voice coil coupled to the bobbin and including first windings disposed within the first region of high flux density and second windings disposed within the second region of high flux density.

13. The electromagnetic transducer of claim 12 wherein the motor structure further includes:
a first end plate magnetically coupled to the first magnet opposite the plate means; and
a second end plate magnetically coupled to the second magnet opposite the plate means.

14. The electromagnetic transducer of claim 12 further comprising:
a magnetically conductive frame magnetically coupled to the first magnet opposite the plate means;
wherein the diaphragm is coupled to the frame by an upper suspension component and the bobbin is coupled to the frame by a lower suspension component.

15. The electromagnetic transducer of claim 14 further comprising:
a magnetically conductive end plate magnetically to the second magnet opposite the plate means.

16. The electromagnetic transducer of claim 14 wherein:
the lower suspension component is coupled to a lower end of the bobbin.

17. The electromagnetic transducer of claim 14 wherein:
the bobbin is coupled to the lower end of the bobbin.

18. The electromagnetic transducer of claim 12 wherein the plate means comprises:
a lower top plate magnetically coupled to the first magnet;
an upper top plate magnetically coupled to the second magnet; and
a non-magnetically conductive spacer disposed between the lower and upper top plates.

19. The electromagnetic transducer of claim 18 wherein:
the lower top plate, the upper top plate, and the spacer are of substantially a same thickness.

20. The electromagnetic transducer of claim 12 wherein:
the voice coil comprises a single section of windings extending from the first region of high flux density to the second region of high flux density.

21. The electromagnetic transducer of claim 12 further comprising:
a frame coupled to the motor structure;
an upper suspension component coupling the diaphragm to the frame;
a lower suspension component coupling one of the diaphragm and the bobbin to the frame, the lower suspension component having a plurality of holes disposed about the voice coil;
a plurality of magnetically conductive rods disposed outside the voice coil and extending from the first magnet to the second magnet and passing through the holes in the lower suspension component.

22. The electromagnetic transducer of claim 21 further comprising:
a magnetically conductive end plate magnetically coupled to the second magnet opposite the plate means;
wherein the rods comprise bolts coupled to the end plate and to the frame to secure the motor structure to the frame.

23. An electromagnetic transducer comprising:
(a) a motor structure including,
a first radially-charged internal magnet, and
magnetically-conductive flux focusing ring means magnetically coupled to an outer surface of the magnet for defining at an outer perimeter of the focusing ring means a first region of high flux density and a second region of high flux density separated by a region of lower flux density,
wherein magnetic flux in the two regions of high flux density is in a substantially same radial direction, and
wherein return paths from the regions of high flux density to the magnet are primarily via ambient air; and
(b) a diaphragm assembly coupled to the motor structure and including,
a diaphragm,
a bobbin coupled to the diaphragm and disposed around the motor structure,
a voice coil coupled to the bobbin and having first windings disposed within the first region of high flux density and second windings disposed within the second region of high flux density.

24. The electromagnetic transducer of claim 23 wherein the motor structure further comprises:
a magnetically conductive core disposed within the radially-charged magnet.

25. The electromagnetic transducer of claim 23 wherein the motor structure further comprises:
a first axially-charged internal magnet disposed adjacent a first end of the focusing ring means such that like poles of the radially-charged magnet and of the first axially-charged magnet are facing the focusing ring means.

26. The electromagnetic transducer of claim 25 wherein the motor structure further comprises:
a second axially-charged internal magnet disposed adjacent a second end of the focusing ring means such that like poles of the radially-charged magnet and of the second axially-charged magnet are facing the focusing ring means.

27. The electromagnetic transducer of claim 26 wherein the focusing ring means comprises:
two steel top plates; and
a second radially-charged internal magnet disposed axially between the top plates and polarized opposite the first radially-charged magnet.

28. The electromagnetic transducer of claim 23 wherein the radially-charged magnet comprises:
a conical magnet.

29. The electromagnetic transducer of claim 23 wherein:
the focusing ring has an outer surface having a shape tapered inward at its ends.

30. An electromagnetic transducer comprising:
a frame;
an internal magnet geometry air-return motor coupled to the frame and providing two regions of high magnetic flux density at respective axial positions at an outer diameter of the air-return motor; and
a diaphragm assembly including a diaphragm, an upper suspension component coupling the frame to the diaphragm, a bobbin coupled to the diaphragm and extending over the air-return motor, a lower suspension component coupling the frame to one of the diaphragm and the bobbin, and a voice coil partially disposed within each of the regions of high magnetic flux density.
